(19) United States
(12) Patent Application Publication
(10) Pub. No.: US 2025/0194626 A1
(43) Pub. Date: Jun. 19, 2025

(54) METHOD AND SYSTEM FOR THE PRODUCTION OF COFFEE TABLETS

(71) Applicant: LUIGI LAVAZZA S.P.A., Torino (IT)

(72) Inventors: Silvia BARUS, Torino (IT); Massimo QUINTI, Torino (IT); Benedetta MAGNI, Torino (IT); Patricia FRANCISCO DE OLIVEIRA, Torino (IT); Julie DIMAKOU, Torino (IT)

(21) Appl. No.: 18/875,474

(22) PCT Filed: May 22, 2023
(86) PCT No.: PCT/IB2023/055241

§ 371 Date: Dec. 16, 2024

(30) Foreign Application Priority Data
Jun. 17, 2022 (IT) 102022000012902

(51) Int. Cl. A23F 5/12; A23P 10/28

(52) U.S. Cl. CPC A23F 5/125; A23P 10/28

(57) ABSTRACT

A method for the production of coffee tablets comprises the steps of: i) providing a uniformly moistened mass of roasted and ground coffee, having a moisture content by weight of between 3 and 11%; ii) feeding the moistened mass to a dosing device; iii) placing a dose of moistened coffee into a cavity of a moulding equipment, the cavity having a bottom surface (35a), a head surface (32a) and a peripheral surface, said the bottom surface (35a), said head surface (32a) and at least a portion (22a) of said peripheral surface being configured to delimit a compression space (CS) of the moistened coffee dose; iv) compressing the dose of moistened coffee (DGC) into the cavity (22) to form a coffee tablet (1); v) removing the coffee tablet (1) from the cavity (22). Step iv) comprises compressing the dose of moistened coffee (DGC) while said portion of the peripheral surface (22a) is heated at a different temperature, preferably lower, than a temperature at which at least one of the bottom surface (35a) and the head surface (32a) is heated.

### TECHNICAL FIELD

The present invention relates to the coffee industry and has been developed with particular reference being paid to the production of tablets, or similar dosage units free of a functional casing, formed starting from roasted and ground coffee powder, for use in beverage preparation devices. The tablets obtainable by the methods and systems according to the invention are designed for the preferred use on automatic and semi-automatic preparation machines, but their predisposition for use on other preparation devices, such as “moka” or “Neapolitan” type coffee makers, or cafetiere coffee makers, or percolator devices is not excluded.

### Background Art

The preparation of liquid food products on preparation machines or devices, starting from pre-portioned doses of a precursor, is widespread, in particular for the preparation of hot drinks, such as espresso.

In some known solutions, the dose of precursor of the beverage has a functional outer casing, i.e., it is packaged in a more or less rigid capsule, and the corresponding preparation machine is designed to cause a preparation liquid (typically water) to pass through this capsule, to dispense the drink out. For other preparation devices, the dose of the precursor is contained in a functional casing that is flexible and permeable to water, typically a paper casing, usually referred to as a “pod”. In some cases, the pods are intended for use on automatic or semi-automatic preparation machines, while in other cases they are intended for use on coffee makers or percolators. Even in these solutions, anyway, the flexible and permeable functional envelope is made to pass through by a flow of the preparation liquid.

The packaging of the single dose of precursor in its functional casing implies various drawbacks, linked to the higher cost of the product, the greater complexity of the production process, the need for correct ecological disposal of used capsules or pods and the environmental impact due to related gas emissions.

These issues have been addressed in the past by proposing the creation of precursor dosing units with a self-supporting structure that does not necessarily require a functional outer casing, in particular in the form of tablets or pills. These tablets or pills can be packaged in groups within the same container, for example a bag formed with a material having good oxygen-barrier properties, so as to avoid a rapid deterioration of the product (typically due to oxidation phenomena). These tablets are therefore designed to be inserted into the relevant preparation machines as such, i.e., without the beverage preparation process presupposing the use of the functional casing.

EP 0229920 A1 discloses a method for the preparation of coffee tablets, which involves compaction, with a compressive force ranging from 20.7 MPa to 48.3 MPa, of a mass of roasted and ground coffee particles, having a moisture content of at least 3% by weight and an average coffee particle size of 0.4 mm to 2.0 mm. Preferably, the moisture content of roasted and ground coffee particles is from 3% to 6% by weight, their average size is from 0.6 mm to 1.2 mm, and the compressive force is from 27.6 MPa to 41.4 MPa. The pressure used is such that the volume of the mass of roasted and ground coffee particles is reduced to a value between 55% and 30% of the original volume of the moistened mass. The final density of the tablets is between 0.60 and 0.95 g/cm³. The compaction operation is performed by placing a dose of coffee particles between opposing elements and pushing the elements towards each other. These opposing elements include a mould matrix, defining a tubular pocket of the desired shape open at one end, and a punch received slidingly in the pocket.

In a first practical example of the aforementioned document, a single tablet is obtained from 60 grams of moistened coffee powder, the tablet having a diameter of 100 mm and a thickness of about 9.2 mm, with flat end walls. Such a tablet can be used for the preparation of about 8-10 cups of coffee. In a different comparative example, five different portions of 4% moistened coffee powder, with an average coffee particle size of 1 mm, were subjected to different compression forces, starting from a thickness of 23.5 mm. The results are as follows.

TABLE 1

| Compression | Average final | Tablet volume | |
|---|---|---|---|
| (MPa) | thickness (mm) | (% original mass) | Notes |
| 17.2 | 11.7 | 49.8 | Broken edges |
| | | | Lacks strength |
| 28.5 | 10.3 | 43.8 | Edges even |
| | | | Better strength |
| 39.5 | 9.2 | 39.2 | Edges good |
| | | | Strong |
| 43.9 | 8.7 | 37.0 | Oil showing |
| | | | Reabsorbed back |
| 50.5 | 8.0 | 34.0 | More oil |
| | | | Darker than above |
| | | | Glazed |

A further comparative example of the document concerns tablets of 7.62 cm in diameter, with a weight of 24 or 47 g, as well as tablets of 10.2 cm in diameter, with a weight of 47 g.

WO 2019/106413 A1 discloses another method for the preparation of coffee tablets, which involves grinding of coffee beans, in order to obtain a corresponding powder, the subsequent humidification of the coffee powder in a cloud of cold vapor, and the formation of a dose of moistened coffee powder, by insertion into a mould matrix. The dose is then heated and pressed, to form a tablet having the desired shape, with a compression that does not cause the deformation of the individual coffee particles. Humidification of the coffee powder is carried out during loading of the dose in the mould matrix, and the powder is heated both in the loading phase and in the compression phase, increasing the temperature of the mould parts to a predetermined value between 60 and 86° C., in order to determine the sintering of the coffee powder particles, and thus obtain a tablet having compact and stable form. The size of the coffee particles is between 200 to 1000 microns, depending on the method of extraction of the beverage for which the tablet is intended, with a PSD (particle size distribution) of 65 to 90% within 200 microns. The dose of coffee powder is from 6-12 grams. Cold steam is obtained from an aqueous solution of sodium chloride from 2 to 10% and sucrose from 2 to 10%. The cold steam supply takes place by pulses, with a feeding time that does not exceed two seconds.

The examples in the document provide two possible methods, with starting material being roasted coffee with a moisture content of between 3 and 6%, and raw coffee with a moisture content of between 9 and 12%. In both cases, the weight of the starting doses is 7 and 12 g. By compressing the doses at pressures between 40-160 MPa, tablets with a mass of 7.2 and 11.8 g were obtained, with a density between 0.95- and 1.29 g/cm 3, and a residual moisture of 3-4.5%.

WO 2021/033011 A1 discloses a further process to produce coffee tablets, wherein a dose of coffee powder is moistened and fed to a mould matrix, to be then heated and subjected to compression. The starting dose comprises at least a first fraction of powder, with particle sizes between 500 and 900 microns, and a second fraction of powder, with particle sizes of less than 200 microns, respectively, to form a tablet weighing between 6 and 12 grams, wherein the first fraction is 70 to 90% by weight, and the second fraction is 10-30% by weight. Humidification is performed by first spraying a liquid solution on the inner surface of the mould matrix, then followed by a sequential feeding of 50-70% of the second fraction, then by 100% of the first fraction, and finally of the remaining 50-30% of the second fraction, followed by compression by punch, with simultaneous heating.

The surface layer of the tablet is heated by electric heating of the matrix and the punch to 55-85° C., or else by microwaves. The effect of the indicated method would be that the first fraction of larger particles would be inside the tablet, and surrounded on the outside by a dense layer of the finest particles.

The known methodologies indicated have some drawbacks, related to the failure of achieving correct organoleptic profiles in the final drink and to problems of integrity of the tablets, due for example to dusting, breakage and, above all, to the formation of lateral cracks of the tablets.

### AIM AND SUMMARY

In its general terms, the present invention aims to solve the above said disadvantages by means of an improved method for the production of coffee powder tablets. An auxiliary aim of the invention is to indicate one such method that can be implemented in a simple way.

At least one of the aforementioned aims is achieved, according to the invention, by a method, a system and a tablet having the characteristics indicated in the attached claims. The claims form an integral part of the technical teaching provided herein in connection with the invention.

### BRIEF DESCRIPTION OF THE DRAWINGS

Further aims, characteristics and advantages of the invention will result from the description that follows, made with reference to the attached drawings, provided purely as a non-limiting example, wherein:

FIGS. 1 and 2 are a schematic perspective view and an elevation view of a coffee powder tablet according to possible embodiments;

FIG. 3 is a schematic representation of a possible method for the production of coffee powder tablets according to possible embodiments;

FIG. 4 is a partial and schematic perspective view of equipment for moulding coffee powdered tablets, which can be used in a process according to possible embodiments;

FIG. 5 is a partial and schematic section of equipment of the type shown in FIG. 4, in a closed or compression condition;

FIG. 6 is a schematic cross-sectional representation of a portion of the equipment of FIG. 5, intended to to identify certain parts of a compression space;

FIGS. 7, 8 and 9 are partial and schematic sections of a punch of equipment of the type shown in FIG. 4, according to different possible embodiments; and

FIG. 10 shows photographic images of coffee tablets obtained as a result of a comparative test.

### DESCRIPTION OF PREFERRED EMBODIMENTS

Reference to an embodiment in this description indicates that a particular configuration, structure, or characteristic described in relation to the embodiment is included in at least one embodiment. Thus, phrases such as “in an embodiment”, “in various embodiments” and the like, possibly present in different places in this description, do not necessarily refer to the same embodiment. In addition, particular conformations, structures or characteristics defined within this description can be combined in any appropriate way in one or more embodiments, even different from those depicted. The numerical and spatial references (such as “upper”, “lower”, “top”, “bottom”, etc.) used herein are for convenience only and therefore do not define the scope of protection or the scope of the embodiments. In this description and in the attached claims, the indication that the tablets or dosage units mentioned have a self-supporting structure free of a functional outer casing is intended to indicate that these tablets or units do not require, for the extraction of the beverage (liquid coffee), the presence of an outer casing, such as a capsule or a flexible and permeable coating, that is, they are designed to be inserted as such in the relevant preparation machines: this, of course, does not exclude that for marketing and storage purposes, the tablets or dosage units are packaged in suitable containers, such as bags, packages, trays, etc.

The same reference numbers are used in the figures to indicate similar or technically equivalent elements.

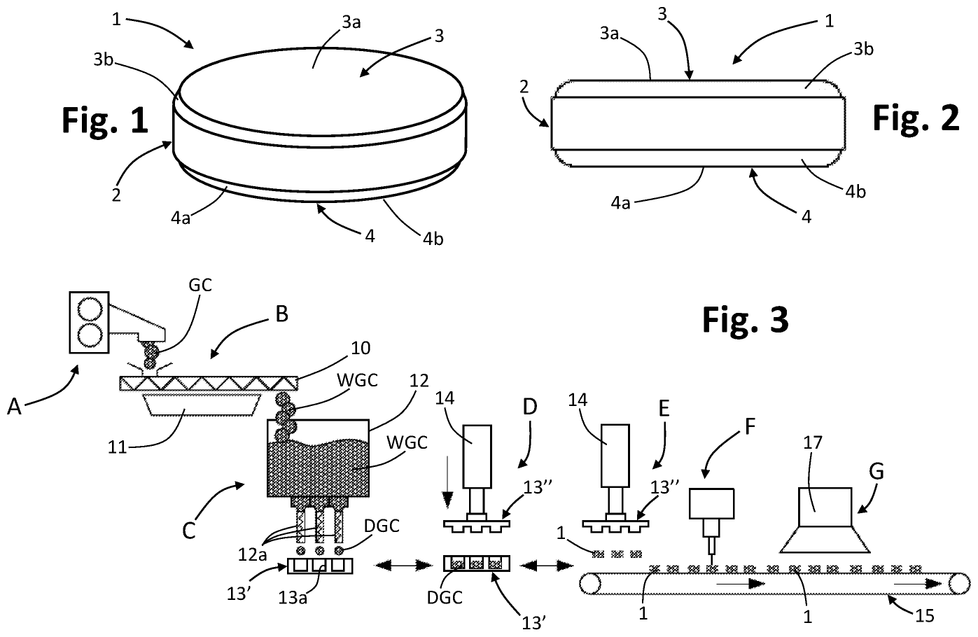

FIGS. 1 and 2 shows for exemplifying purposes a coffee dosage unit or coffee tablet obtainable according to possible embodiments of the invention, consisting of a compacted mass of coffee powder, having a self-supporting structure and without a functional casing (i.e., without a capsule body or a casing body made of flexible and permeable material).

In the case exemplified, the tablet 1 has a substantially cylindrical central portion 2, and two opposite end portions 3 and 4, of a reduced diameter. Portions 3 and 4 each define an end surface 3a, 4a of the tablet 1, preferably flat, and preferably a respective radiused peripheral part 3b, 4b, for connection to the central portion 2. As explained below, embodiments of this type can be advantageous for the extraction of tablet 1 from the relative mould, during production.

However, other solid forms for the tablet are not excluded. Preferential forms are those characterized by geometry of revolution (including essentially toroidal or frusto-conical forms), which allow to obtain an optimal compaction of the coffee powder, in the method described below: in particular, these forms allow to maintain the equidistance of the peripheral surface of the tablet with respect to the core or center thereof, which is particularly advantageous in the proposed method, for the reasons explained below. Other possible shapes for the tablets are those distinguished by a curved surface (such as substantially spherical or ellipsoidal shapes).

FIG. 3 represents in the form of a simplified diagram a possible sequence of operations of a method for the production of tablets according to the invention.

A designates a first step, consisting in obtaining a mass GC of roasted and ground coffee. The second step B represents instead a phase of a preferably homogeneous humidification of the mass GC, in order to obtain a mass of moistened coffee WGC, i.e., with a predetermined water content. The purely explanatory example illustrates the case of a horizontal screw mixer 10, arranged above a possibly heated tank 11, so that the resulting water vapor penetrates into the mixer 10, and then into the coffee powder. Humidification can also be done by spraying water (or other suitable aqueous solution) directly on the ground coffee GC, with simultaneous or subsequent mixing, in order to obtain a mass WCG with a predetermined uniform moisture content. According to one aspect of the invention, the predetermined moisture content is approximately between 3 and 11% by weight of the mass WGC, preferably between 4 and 6%.

C designates a third step, wherein the mass of moistened coffee is fed to a dosing system 12 by which, by means of at least one dosing nozzle 12a, a dose DGC of moistened coffee powder is fed into a corresponding cavity 13a of a moulding equipment, e.g., a cavity defined at least partially in a lower mould part 13′. In the schematic example, the system 12 includes a plurality of dosing nozzles 12a to adduce a plurality of doses DGC in the respective cavities of the mould part 13′. However, the case of a single dosing nozzle, controllable for the delivery of the dose DGC in a lower single-cavity mould part, or for the successive delivery of several doses DGC in each cavity of a multi-cavity mould part, is not excluded from the scope of the invention. The dosing system 12 can be made according to any technique known in the industry.

Step D schematically represents a fourth step, in which each dose of moistened coffee DGC is compressed into the respective cavity 13a of the mould part 13′, in particular through at least one corresponding upper mould part 13″, for example having at least one punch insertable and sliding in the cavity itself. The actuation system 14 of moulding equipment 13′, 13″ (for example of the upper mould part 13″ only) may be of any known design, preferably based on the use of at least one hydraulic cylinder. In various embodiments, the compression of the dose can be non-continuous, i.e. carried out with pressure and release phases, with a modulation of pressure according to different types of profiles (increasing pressure, decreasing pressure and/or various combinations thereof), with modularity of the pressure phases; this solution can be advantageous depending on the type of coffee used, its starting characteristics, the desired organoleptic profile.

As will be seen, according to one aspect of the invention, the at least two parts 13′, 13″ of the moulding equipment delimit therebetween a compression space or volume of the dose DCG, wherein the surfaces that delimit this space are heated in a differentiated way. Also in this case, in possible embodiments, heating can be non-continuous, that is, it can be carried out with different heating phases, with temperature modulation according to different types of profiles (increasing temperature, decreasing temperature, pauses in heating, and/or various combinations), with modularity of the heating phases; this solution can also be advantageous depending on the type of coffee used, its starting characteristics, the desired organoleptic profile.

The compression can therefore be carried out with simultaneous heating of the at least two mould parts 13′ and 13″. In case of heating with a temperature modulation that includes pauses in heating, part of the compression can be carried out in the absence of heating.

Step E exemplifies the subsequent step of extracting each tablet 1 from the relevant cavity of the moulding equipment, for example from the mould part 13′. Extraction may be carried out in any known way, for example by using a system using suction extraction elements, or by providing a lower mould part 13′ in which the bottom of each cavity 13a is itself defined by a lower punch, which can be slid upwards to lift the tablet to a position outside the cavity; alternatively, there can be provided for the lifting of a section of the lower mould part 13′, or the section that defines only the peripheral surface of the corresponding cavity 13a, so that each tablet remains resting on an underlying stationary punch that defines the bottom of the cavity itself.

Regardless of the realization of the mould and the method of extraction, the tablets 1 can then be placed on a conveyor system 15, for the purpose of subsequent operations. In the schematic example, a marking step F is provided, during which, on the top surface of the tablets 1, a distinctive sign or identification code is defined in a known manner. Marking can also be carried out by means of corresponding recessed or embossed impressions on the respective parts of the mould. The marking step F can be followed by a step G of residual heat removal, for example via a suction system or with ventilation 17.

Afterwards, packaging of the tablets 1 can be carried out. The tablets 1 can be packaged individually or in groups, in suitable containers with adequate oxygen-barrier properties, such as bags, packages, trays, tubular containers. The tablets 1 may be possibly vacuum-packed in the appropriate packages.

As indicated above, according to the invention, the predetermined moisture content of the coffee powder to be introduced into the table moulding cavity is indicatively comprised between 3 and 11% by weight of the corresponding dose, preferably between 4 and 6% by weight. According to a further aspect of the invention, the dose of moistened coffee necessary for the formation of a tablet is subjected to compression while an intermediate region of the compression space has a different temperature than at least one of a lower and an upper region of the compression space. Preferably:
the aforesaid intermediate region is defined by a corresponding portion of the peripheral surface of the moulding cavity;
the lower region is defined by the bottom surface of the moulding cavity, which may belong to a lower punch, and
the upper region is defined by the surface of an upper punch, driven to actively compress the dose of moistened coffee DGC.

In various embodiments, the moulding arrangement or equipment used for the implementation of the invention comprises at least two mould parts, which are configured to compress the dose of moistened coffee therebetween within a corresponding moulding cavity, wherein the at least two mould parts define a bottom surface, a head surface and a peripheral surface of said cavity.

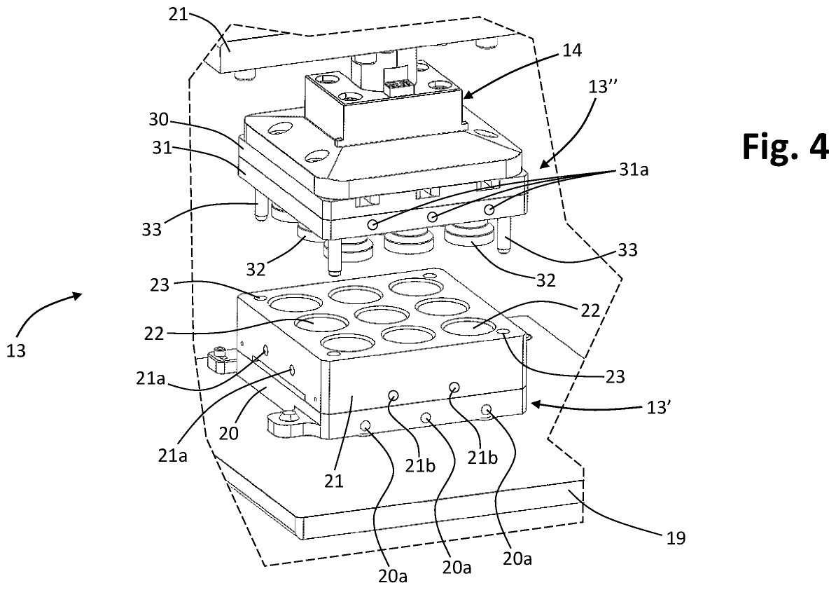

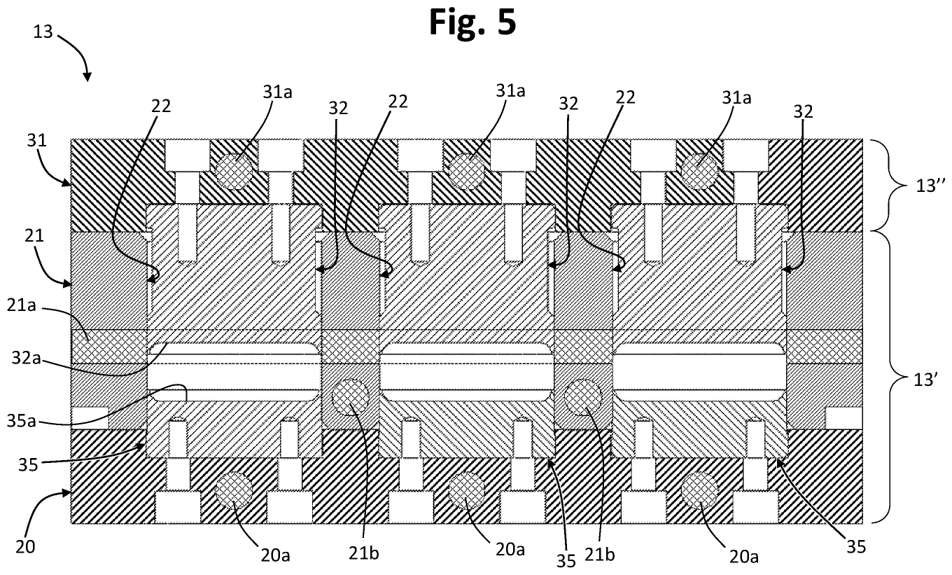

FIG. 4 represents, for mere exemplifying purposes, a possible equipment that can be used for the moulding of coffee tablets according to the invention, indicated as a whole by 13, which basically includes two mould parts. In this figure, 19 designates a base, on which a lower mould part 13′ is mounted, here obtained by two overlapping sections, designated by 20 and 21, preferably formed with a thermally conductive material, such as a metal material, for example stainless steel. As shown in FIG. 5 (wherein the mould 13 is represented in cross-section, in a closed position), the lower section 20 defines or has associated thereto a series of punches 35, here substantially cylindrical in shape, which are each inserted inside a respective through-cavity 22, here substantially cylindrical in shape, of the upper section 21. In the example, the lower mould part 13′ has nine moulding impressions, each defined by a cavity 22 and the corresponding lower punch 35, but of course the number of cavities can be different. In the example, assume that sections 20 and 21 of the mould part 13′ are stationary, and that the extraction of the tablets 1 from the moulding cavities 22 is carried out by means of a gripper/lifting system which operates by suction. By the way, in other embodiments, sections 20 and 21 of the mould may be separable mould parts, with an extraction of the tablets of a different type.

Again referring to FIGS. 4 and 5, 13″ indicates an upper mould part, which is connected to a corresponding actuation system 14 and which may also have two superimposed sections 30 and 31, although this is not an essential feature. From the lower surface of the section 31 a series of upper punches 32 protrude, here substantially cylindrical in shape, in a number corresponding to the number of the cavities 22 of the lower mould part 13′. Again from the lower surface of the section 31 of the mould part 13″ there protrude a series of positioning and guiding pins 33, intended for insertion in respective positioning and guiding passages 23 provided for in the section 21 of the lower mould part 13′.

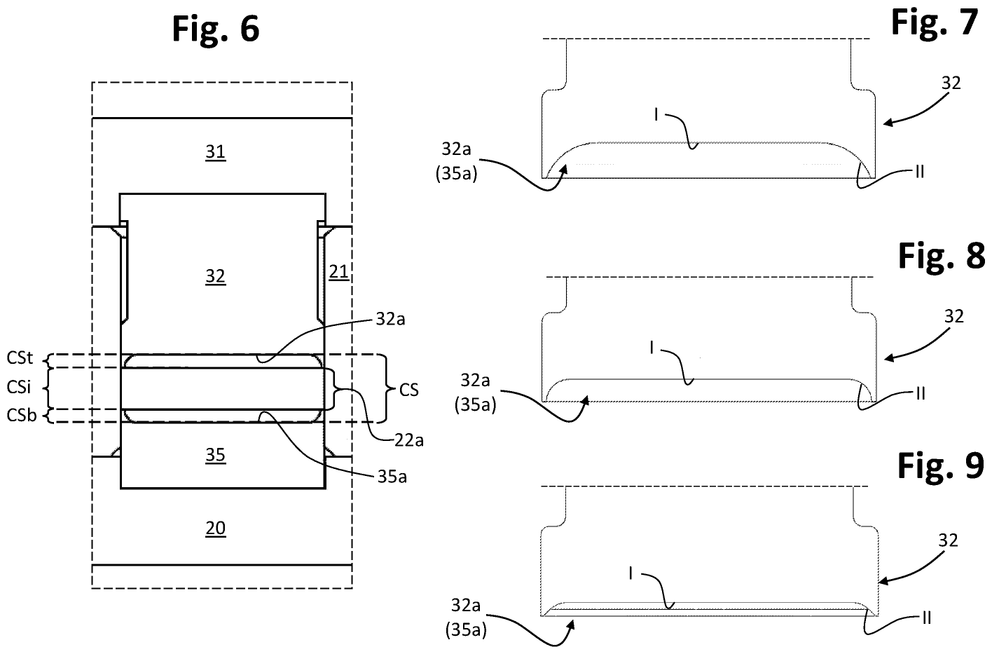

The opposing surfaces of the punches 32 and 35 realize in the example a bottom surface and a head surface, respectively, of the moulding cavity. FIG. 5 shows how, in various preferential embodiments, the above-mentioned opposing surfaces of the punches 32 and 35 define respective shaped surfaces or impression 32a and 35a, intended to give a corresponding shape to the two end faces of the tablet, for example the shape of the portions 3 and 4 of the tablet 1 shown in FIGS. 1 and 2. A limited portion of the cylindrical surface of the cavities 22 (indicated with 22a in FIG. 6), here defined in the mould part 13′, is instead intended to define the peripheral profile of the intermediate portion of the tablet 1.

With the mould 13 in the closed position, as in FIG. 5, each cavity 22 and the corresponding lower punch 35 and upper punch 32 delimit a compression space or volume for a dose of moistened coffee, with this compression space that has:
an intermediate region defined by a corresponding portion of the peripheral surface of the cavity 22,
a lower region defined by the shaped surface 35a of the lower punch 32, and
an upper region defined by the shaped surface 32a of the upper punch 32.

The compression space or volume is designated in FIG. 6 with CS, and its intermediate, lower and upper regions are designated by CSi, CSb and CSt; in the same figure, 22a designates the aforementioned portion of the cylindrical surface of the cavity 22 which identifies the intermediate region CSi.

As mentioned, at least during a compression phase of a dose of moistened coffee DGC aimed at obtaining a tablet 1, the intermediate region Csi of the compression space CS has a different temperature-preferably lower-than at least one of the lower region CSb and the upper region CSt. In various preferential embodiments, both the lower region CSb and the upper region CSt are at a higher temperature than the temperature of the intermediate region CSI; however, in some cases, the intermediate and lower regions may be at the same temperature. In various preferential embodiments, the upper end region CSt is at a higher temperature than the lower end region CSb.

In general, the tests carried out by the Applicant have made it possible to ascertain that preferential temperatures are as follows:
upper end region CSt: between 55 and 100° C.;
intermediate region CSI: between 40 and 95° C.; and
lower end region CSb: between 50 and 95° C.

The Applicant noted that controlled heating of the lateral surface 22a of the compression space CS drastically reduces the problem of side crack formation in the tablet, tied to the springback phenomenon, i.e., a kind of bounce of the mass under compaction that occurs at the time of the release of the compression. Surprisingly, the controlled heating of the lateral surface of the compression space resulted in a significantly lower bounce effect, even compared to “cold” moulding of compressed tablets for more than twice the time, and also at higher pressures. Thanks to the reduction of the bounce effect, in various embodiments it is possible to organize heating and compression of the doses according to successive phases, also with modulation of the parameters or modular management of the phases to adapt the process to different types of coffee and different organoleptic profiles.

The proposed solution of differential heating of the mould therefore allows to effectively solve the problem of the formation of lateral cracks in the tablets, as well as reducing the compaction times to the advantage of productivity, especially in the case of the use of a multi-cavity mould.

This advantageous effect is considered linked to the fact that the use of a lower temperature at the intermediate region Csi of the compression space allows to limit the evaporation of water from the intermediate portion 2 of tablet 1. On the other hand, the use of a higher temperature at the upper region CSt has the effect of compensating for the shorter contact time between the upper punch 32 and the coffee dose DGC, compared to the intermediate region Csi and the lower region CSb.

In any case, a heating of the entire coffee mass is obtained, according to a controlled temperature gradient between the surface zones and the central zone of the tablet, which allows to reach in this central area a temperature necessary for the agglomeration process (in particular in relation to the so-called caking), indicatively comprised between 40 and 60° C., particularly about 50° C.

The thermographic analysis of the tablets during the moulding phase confirmed an efficient distribution of temperatures, according to a profile with a gradient depending on the zones, wherein the central zone of the tablet is advantageously maintained at lower temperatures preserving the organoleptic profile thereof.

In various embodiments, the differentiated heating in the various regions or surfaces of the space CS is obtained by providing suitable heating means in the different parts of the mould. In various embodiments, a mould part is equipped with means for heating the head surface of the moulding cavity, while the other mould part is provided with means for heating the bottom surface of the moulding cavity, as well as at least a portion of its peripheral surface.

In the case exemplified in FIGS. 4 and 5, the movable mould part 13″ is equipped for the purpose with electrical resistances 31a, intended for heating the punches 32, and particularly their lower surfaces 32a. In the example, the resistances 31a can be arranged in the section 31 of the mould part 13″, from which the punches 32 protrude, with the resistances 31a extending in length each in a position corresponding to a respective row of punches 32 (three punches 32, in the case exemplified). In embodiments of this type, the heat transmission takes place by conduction, between the section 31, essentially in plate form, and the punches 32; for this purpose, the section 31 and the punches 32 are preferably made of thermally conductive materials, preferably metal materials, for example stainless steel.

In various embodiments, a substantially similar heating arrangement is also provided for the heating of the lower punches 35, and therefore with a plurality of electrical resistances 20a arranged in the section 20 of the mould part 13′, with each resistance 20a extending in length at a respective row of punches 35 (three punches 35, in the case exemplified). Also in this case the heating of the punches 35, and particularly of their upper surfaces 35a, and the transmission of heat takes place by conduction, between the section 20, substantially in the form of a plate, and the punches 35; as with the mould part 13″, the section 20 and the punches 35 are preferably made of thermally conductive materials, preferably metal materials, for example stainless steel.

Similar heating resistances can be used for heating the cavities 22 of the section 21 of the mould part 13′, and particularly of the corresponding portions of the surface 22a which delimit the compression spaces Cs. In the case exemplified, section 21, preferably also made of a thermally conductive metal material, such as stainless steel, has two series of electrical resistances 21a and 21b, also longitudinally extended.

In various embodiments, the resistances 21a and 21b are arranged crosswise at different heights within section 21 (see e.g. FIG. 5). With such an arrangement the resistances 21a and 21b therefore form a sort of grid structure, with each cavity 22 being heated by means of respective portions of at least two different crossing resistances 21a and 21b. In the non-limiting example, two resistances 21a and two resistances 21b are provided for, so that the stretches of the cavities closest to the external peripheral profile of the section 21 are subject to a slightly lower conduction heating, compared to the sections closest to the electrical resistances. There is nothing to prevent in principle the provision of four resistances 21a and four resistances 21b, so that even at the abovementioned portions of the cavities closest to the outer peripheral profile of section 21 there extends a respective portion of the resistance 21a or 21b: the Applicant has however found that, in practice, and referring to the exemplary case of a nine-cavity mould 22, the use of only four resistors 21a and 21a does not significantly affect the quality of the moulding, and above all simplifies the realization of the section 21, allowing to reduce its weight and overall dimensions. The various sections 20, 21 and 31 provided with resistances are equipped with suitable temperature sensors, for example in the form of thermocouples, for the detection and control of the temperature of the surfaces 22a, 31a and 35a according to process requirements. The operation of the resistances is managed by a control system, not represented, preferably according to the signals acquired via the temperature sensor means. The use of electrical resistances is advantageous in terms of temperature control, but in possible variant embodiments they could be replaced by ducts in which a suitable heating fluid flows, for example water.

In other embodiments, the heating resistances can be arranged vertically, and extend each in a region comprised between four adjacent cavities. Another possibility is to provide a heating resistance inside each punch 35, for example arranged vertically (although this involves a greater vertical encumbrance of the corresponding mould part).

In general terms, the temperatures chosen for the various regions of the compression space CS, as well as the initial humidity value of the corresponding coffee powder (in any case of between 3 and 11% by weight) and the diameter of the tablets (preferably indicatively variable between 3.5 and 5.5 cm), depend on variables such as:
a) the type of coffee and the roasting color;
b) the grain size of the coffee powder;
c) the ×50/powder ratio;
d) the amount of coffee powder in the single dose;
e) the thickness of the tablet;
f) the compression time of the dose of coffee powder;
g) the force and the compression profile exerted on the dose of coffee powder;
h) the desired residual moisture value for the tablet;
i) the desired density of the tablet;
l) the desired mass loss;
Variables that led to satisfactory results in the tests conducted by the Applicant are the following.
a) Type of coffee and roasting color: Arabica, Robusta, Arabica/Robusta blends, with roasting color from 25 to 65°N.
b) Granulometry: from 200 to 700 μm, preferably between 270 and 450 μm for espresso coffee and between 350 and 550 μm for filter coffee.
c) ×50/powder ratio: 15 to 25 μm for espresso coffee and 20 to 35 μm for filter coffee.
d) Quantity: 4 g to 20 g, preferably 4-11 g for espresso and 6-20 g for filter coffee.
e) Thickness: from 5 mm to 25 mm, preferably 5-20 for espresso and 8-25 for filter coffee.
f) Compression time: up to 180 seconds.
g) Compressive force and profile: up to 17 kN per cavity, preferably between 7 and 8.5 kN.
h) Residual moisture value: 2 to 5%.
i) Desired density: between 0.4 and 0.9 g/cm 3, preferably between 0.5 and 0.6 g/cm³.
l) Desired mass loss: less than 5%.

As described in relation to FIGS. 1 and 2, in preferential embodiments, the tablets 1 obtained by the process according to the invention do not have exactly cylindrical shape, having instead a shape characterized by a central portion 2 substantially cylindrical, and two shaped end portions 3 and 4, wherein portions 3 and 4 define each:
an end surface 3a, 4a of the tablet 1, preferably flat and with a diameter smaller than the central portion 2, and
a radiused peripheral part 3b, 4b, for connection to the central portion 2.

In this perspective, FIGS. 7, 8 and 9 represent possible impressions 32a of the punches 32, preferably corresponding to those of the bottom of the moulding cavities (this bottom being represented in the given examples by the punches 35, with the corresponding impressions 35a). The shown profiles allow for obtaining tablet shapes of the type shown in FIGS. 1 and 2, the surfaces I and II being intended to define the end surfaces (3a, 4a) and the connecting surfaces (3b, 4b) of the tablets, respectively.

The impression in FIG. 7, where the radius of the surface II is substantially equal to or close to 90°, is particularly advantageous in order to eliminate breakage during the removal of the tablets from the mould and the loss of mass in the same tablets. This shape, however, implies that, for the purpose of lifting the tablets (particularly from the lower punch), a torsion is applied to them: this complicates the process, and can cause dusting during extraction from the mould.

The impressions referred to in FIGS. 8 and 9, in which the radius of the surface II is gentler (closer to 45°, in any case comprised between 30° and 60°) allows for an easier removal of the tablets, without the need for torsion (and therefore without dusting), and without substantially determining the formation of lateral cracks.

The profiles referred to in FIGS. 7-9 have been subjected to comparative tests by the Applicant, together with a substantially completely cylindrical compressed profile. The test conditions were as follows:
starting coffee powder with moisture content between 5.3 and 5.7%
ratio ×50/powder=324 μm/18.79%
surface temperatures 32a, 22a, 35a: 85/80/80° C.
compaction time: 30 s.

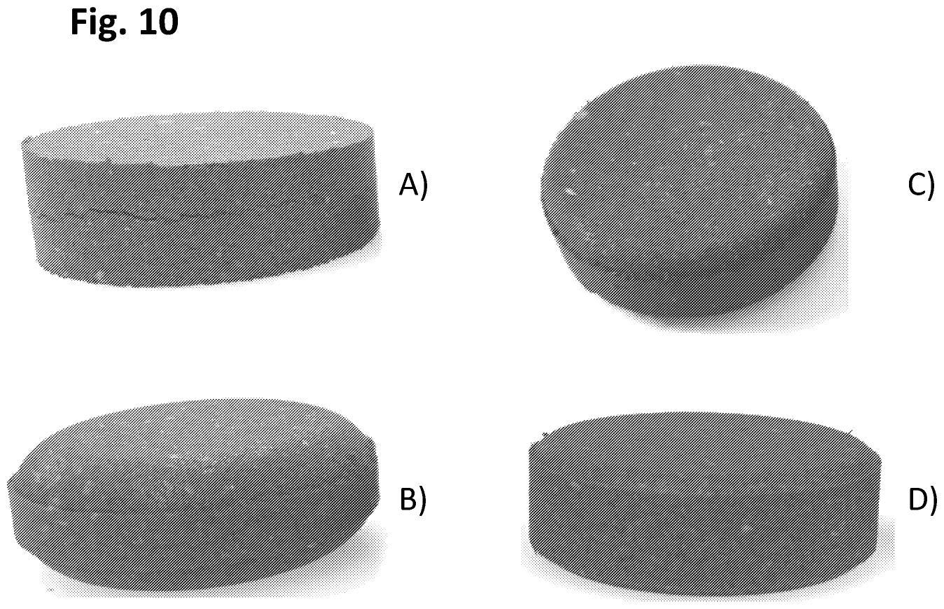

The cylindrical shape showed, compared to the shapes obtained with the profiles of FIGS. 7-9, a much higher mass loss in the tablets (1.07% vs. 0.56%, 0.66% and 0.71%) and, above all, the formation of lateral cracks with an incidence of more than 50%. FIG. 10 shows photographic images representative of the result of the comparative test; in this figure, Part A) relates to the fully cylindrical tablet, while Parts B), C) and D) relate to tablets obtained from the end profiles of FIGS. 7, 8 and 9 respectively.

From the given description the characteristics and advantages of the present invention are clear. The proposed solution makes it possible to quickly and easily produce tablets for the extraction of beverages, starting from roasted and ground coffee powder, in which the problem of the formation of lateral cracks in the tablet is eliminated, or in any case drastically reduced.

It is clear that numerous variants are possible for the person skilled in art, without leaving the scope of invention as defined by the claims that follow.

It should be noted, for example, that one or more parts of the process (for example one or more of the phases C-F of FIG. 2) can be carried out in a nitrogen atmosphere.

In possible variant embodiments, part of the coffee mass designed intended to make a tablet may include a smaller fraction of soluble coffee, which can be mixed homogeneously with the roasted and ground coffee, or confined to a central area of the tablet, or else layered within the tablet.

The practical realization of the moulding equipment may vary from that exemplified in the figures, without prejudice to the provision of heating means or elements designed to heat in a differentiated way at least a portion of the peripheral surface of the moulding cavity with respect to at least one of the bottom surface and the head surface of the same cavity. For example, the mould might include at least three parts, such as:
an intermediate part, having a through hole so as to define the peripheral surface of the moulding cavity, and provided with heating means designed to heat at least part of that peripheral surface (in particular its part which laterally delimits the compression space or volume of the coffee powder dose),
a lower part, defining a lower punch, the proximal end of which defines the bottom surface of the compression space or volume, and provided with heating means designed to heat said bottom surface, and
an upper part, defining an upper punch, the proximal end of which defines the head surface of the compression space or volume, and provided with heating means designed to heat said head surface.

In embodiments of this type, the intermediate part of the mould could possibly be stationary, and the lower and upper mould parts could be movable, to compress the dose of coffee.

Another possibility is to provide a mould in two parts, each of which defines a respective end surface (head surface or bottom surface) and a respective part of the peripheral surface of the compression space or volume. In this case, each mould part will be equipped with means designed to heat the end surface thereof and the respective part of the peripheral surface. In embodiments of this type, one or both the mould parts can be movable, to compress the coffee dose therebetween.

1. A method for the production of coffee tablets, or similar coffee dosing units having a self-supporting structure without a functional outer casing, comprising the steps of:
i) providing a moistened mass of roasted and ground coffee, having a moisture content of between 3% and 11%;
ii) feeding the moistened mass to a dosing device to obtain doses of moistened coffee;
iii) placing a dose of moistened coffee into a cavity of a moulding equipment, the cavity-having a bottom surface, a head surface and a peripheral surface, said bottom surface, said head surface and at least one portion of said peripheral surface being configured for delimiting a compression space of the dose of moistened coffee;
iv) compressing the dose of moistened coffee into the cavity to form a coffee tablet;
v) extracting the coffee tablet from the cavity;
wherein step iv) comprises compressing the dose of moistened coffee while said portion of the peripheral surface is heated at a different temperature than a temperature at which at least one of the bottom surface and the head surface is heated.

2. The method according to claim 1, wherein the bottom surface and the head surface are both at a temperature higher than the temperature of said portion of the peripheral surface.

3. The method according to claim 2, wherein the head surface is at a higher temperature than the bottom surface.

4. The method according to claim 1, wherein:
the head surface is at a temperature comprised between 55 and 100° C.;
said portion of the peripheral surface is at a temperature comprised between 40 and 95° C.; and
the bottom surface is at a temperature comprised between 50 and 95° C.

5. The method according to claim 1, wherein the roasted and ground coffee has a grain size of between 200 and 700 μm, or between 270 and 450 μm for espresso coffee or between 350 and 550 μm for filter coffee.

6. The method according to claim 1, wherein the coffee tablet:
is a tablet for the preparation of espresso coffee, and has a thickness of between 5 and 20 mm; or
is a tablet for the preparation of filter coffee, and has a thickness of between 8 and 25 mm; or
has a diameter of between 3.5 and 5.5 cm.

7. The method according to claim 1, wherein the dose of moistened coffee has a weight:
between 4 and 11 g, if the coffee tablet is a tablet for the preparation of espresso coffee,
between 6 and 20 g, if the coffee tablet is a tablet for the preparation of filter coffee.

8. The method according to claim 1, wherein the dose of moistened coffee is compressed for a time not exceeding 180 seconds.

9. The method according to claim 1, wherein the dose of moistened coffee is compressed with a compressive force of not exceeding 17 kN.

10. The method according to claim 1, wherein step iv) comprises
providing a mould part having at least one punch with a punch surface defining one of said head surface and said bottom surface,
inserting the punch into a part of the cavity defined by a further mould part, in such a way that the punch surface causes a compression of the dose of moistened coffee,
extracting the punch from the cavity.

11. A coffee tablet, or similar coffee dosing unit having a self-supporting structure without a functional outer casing, obtainable by the method according to claim 1, the tablet being based on roasted and ground coffee powder having a grain size of between 200 and 700 μm, wherein the tablet has:
a weight of between 4 and 20 grams;
a diameter of between 3.5 and 5.5 cm;
a thickness of between 5 mm and 25 mm,
a residual moisture content of between 2 and 5%;
a density of between 0.4 and 0.9 g/cm³.

12. The tablet according to claim 11, having a body that has a shape at least in part substantially cylindrical or having substantially a geometry of revolution.

13. The tablet according to claim 12, wherein the body of the tablet has a central portion which is substantially cylindrical and two opposite end portions each defining an end surface and a radiused peripheral surface connecting to the central portion.

14. A system for the production of coffee tablets, or similar coffee dosing units having a self-supporting structure without a functional outer casing, the system comprising a feeding arrangement, a dosing arrangement and a moulding arrangement,
wherein the feeding arrangement is operable for feeding a moistened mass of roasted and ground coffee to the dosing arrangement,
wherein the dosing arrangement is operable to place a dose of moistened roasted and ground coffee into a corresponding cavity of the moulding arrangement,
wherein the moulding arrangement comprises at least two mould parts operable for compressing the dose of moistened roasted and ground coffee into the cavity, the at least two mould parts defining a bottom surface, a head surface and a peripheral surface of the cavity,
wherein said bottom surface, said head surface and a corresponding portion of said peripheral surface delimit therebetween a compression space of the dose of moistened roasted and ground coffee,
and wherein the moulding arrangement comprises heating means operable for heating said portion of the peripheral surface in a differentiated manner with respect to at least one of said bottom surface and said head surface.

15. The system according to claim 14, wherein the at least two mould parts are operable to compress the dose of moistened roasted and ground coffee and at the same time heat said portion of the peripheral surface at a temperature different than a temperature at which at least one of said bottom surface and said head surface is heated.

16. The system according to claim 14, wherein said portion of the peripheral surface, the bottom surface and the head surface are shaped to give the tablet a shape that is at least partly substantially cylindrical or has a substantially geometry of revolution.

17. The system according to claim 16, wherein said portion of the peripheral surface, said bottom surface and said head surface are shaped to give the tablet a shape having a central portion which is substantially cylindrical and two opposite end portions each defining an end surface and a radiated peripheral surface connecting to the central portion.

18. The system according to claim 14, wherein the heating means comprise electrical resistances.

19. The system according to claim 14, wherein the moulding arrangement comprises at least:
a first mould part defining at least said portion of the peripheral surface of the cavity;
a second mould part having at least one punch which is insertable into the cavity of the first mould part, the punch having a corresponding punch surface defining one of said head surface and said bottom surface,
at least the second mould part being displaceable relative to the first mould part for compressing, via the at least one punch, the dose of moistened roasted and ground coffee into the cavity.

20. The system according to claim 14, comprising an extraction arrangement, configured for obtaining extraction of the coffee tablet from the cavity of the moulding arrangement.
